(19) United States
(12) Patent Application Publication
(10) Pub. No.: US 2001/0034949 A1
(43) Pub. Date: Nov. 1, 2001

(54) Razor tip

(76) Inventor: John Chaucer, Bellflower, CA (US)

Correspondence Address: John Chaucer, 14028 Fidler Avenue, Bellflower, CA, 90706, US

(21) Appl. No.: 09/782,598

(22) Filed: Feb. 12, 2001

Related U.S. Application Data
(60) Provisional application No. 60/165,068, filed on Nov. 12, 1999.

(51) Int. Cl. G01B 3/14

(52) U.S. Cl. 33/562; 33/201; 33/628

(57) ABSTRACT

The RAZOR TIP is a carpenter's pencil sharpening guide. It is designed to be used with a utility knife. Carpenter's pencils are traditionally flat, and wide in shape, making them difficult to sharpen by hand. The RAZOR TIP solves this problem. At the time of this patent application filing there was only one other similar type product available on the market. However, this pencil sharpener was only good for creating a round point on a carpenter's pencil. This defeats the purpose behind the design of the carpenter's pencil. It is designed to provide the user with a flat, and wide lead point which is less susceptible to damage when used on unfinished, and rough surfaces. The RAZOR TIP maintains the original shape of the lead point.

### CROSS-REFERENCE TO RELATED APPLICATIONS

I) Provisional Application for Patent

A) Application Ser. No.

1) 60/165,068

B) Filing date

1) Nov. 12, 1999

### STATEMENT REGARDING FEDERALLY SPONSORED RESEARCH OR DEVELOPMENT

“Not Applicable”.

### REFERENCE TO A MICROFICHE APPENDIX

“Not Applicable”.

### BACKGROUND OF THE INVENTION

The RAZOR TIP is a utility knife sharpening guide for a carpenter's pencil. Carpenter's pencils are used extensively throughout the construction industry. A carpenter's pencil is relatively flat, measuring approximately: 18/32 inches wide by 19/64 inches thick by 6 inches long. The dimensions of the carpenter's pencil make it very difficult to sharpen.

Up until now, most of us have had to rely upon using a utility knife to whittle away a usable point on a carpenter's pencil. Most of the time, you would only get a point that was only useful for a short time, then you would again have to sharpen the pencil. Before you knew it, the pencil would be all used up, and would have to be replaced prematurely. The RAZOR TIP eliminates this problem.

### BRIEF SUMMARY OF THE INVENTION

The rationale behind the design of the carpenter's pencil is to provide it's user with a writing instrument which has a lead point which is thick, wide, and flat, making it far less susceptible to damage than a round pencil. Carpenter's pencils need to be stronger because they are used on many types of unfinished, and rough surfaces. When sharpening these types of pencils it is very important to maintain the shape of the lead. As of the date of this application, there are no sharpening devices on the market which maintain the original shape of the carpenter's pencil lead. The RAZOR TIP sharpening guide does this.

### BRIEF DESCRIPTION OF THE SEVERAL VIEWS OF THE DRAWING

FIG. 1: Top view of the RAZOR TIP.

FIG. 2: Left side view of the RAZOR TIP.

FIG. 3: Right side view of the RAZOR TIP.

FIG. 4: Side view of the RAZOR TIP.

### DETAILED DESCRIPTION OF THE INVENTION

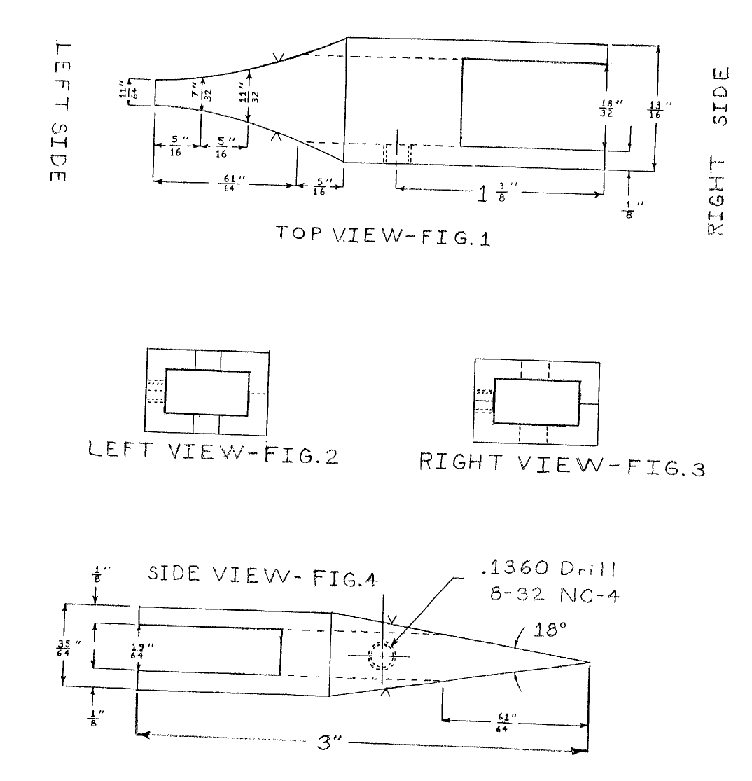

The RAZOR TIP may be used by following these guidelines. To use the RAZOR TIP, you begin by simply sliding the wedge shaped side of the guide (see RIGHT SIDE of TOP VIEW-FIG. 1 of drawings) over the tip of the pencil, lining up the tip of the guide with the tip of the pencil, and securing the guide into place by tightening down the set screw (see SIDE VIEW-FIG. 4 of drawings) located on it's side. The set screw is located in a area designed to eliminate interference between the screw and the utility knife during the sharpening process. Once the guide is secured into place, you begin to sharpen the wide side of the pencil by sliding a utility knife blade along the 18 degree inclined edge of the guide. Carpenter's pencils are made of soft wood, so only a few cuts are required to form a wedge shaped tip. Furthermore, the cutting guide edges are polished in order to assist in the cutting process and to extend the life of the guide.

Once these cuts are made, you are ready to cut the thin sides of the pencil. This is done by loosening the set screw and sliding the curved side of the guide (see LEFT SIDE of TOP VIEW-FIG. 1 of drawings) over the now wedge shaped pencil point. The guide should be secured into place when the tip of the guide is lined up with the tip of the pencil. You begin to sharpen the thin sides of the pencil by sliding the utility knife blade along the curved edges of the guide. At this time, you should have a near flawless point on your pencil. The guide was designed with curved cutting edges so that the cuts which form the lead point begin at the same point around the pencil and provide a uniform appearance.

The production model of the RAZOR TIP will eventually be made of die-cast metal. However, the prototype was fabricated by utilizing the following methods. I began by using two pieces of rectangular shaped hardened steel stock. Any type of hardened steel stock sufficed. The dimensions of the stock were approximately 3 inches long by 13/16th of a inch wide by 35/64th of a inch thick. To create the rectangular cylinder which forms the hollow core of the RAZOR TIP, the following steps were used.

A channel measuring 3 inches long by 18/32nds inch wide by 0.1484 of a inch deep was milled length wise down the center of both pieces of stock. The two pieces of stock were then TIG welded together to form the 3 inch long rectangular cylinder which is 18/32nds by 19/64ths of a inch wide in the core of the RAZOR TIP. The weld marks were then milled down to the surface of the RAZOR TIP to improve it's appearance.

The wedge shaped right side (see TOP VIEW-FIG. 1 of drawings) is formed by milling two 18 degree angles on both the top and bottom of the RAZOR TIP with both angles sharing a common apex, and forming a 36 degree wedge which is 1 47/64th inch long, and 13/16th inch wide. The curve shaped left side (see TOP VIEW-FIG. 1 of drawings) of the RAZOR TIP is formed by milling two irregular curves on both of the 3 inch by 35/64th inch sides. The irregular curves start at a point which is 1 17/64th inches from the tip of the RAZOR TIP. At this point the irregular curves are 13/16th of a inch wide and they taper to form a 11/64th inch wide tip. There is a offset point located at 5/16th of a inch from the tip of the guide where the irregular curves are 7/32nds of a inch wide. There is another offset point located at ⅝ths of a inch from the tip of the guide where the irregular curves are 11/32nds of a inch wide. Finally, there is another offset point located at 61/64ths of a inch from the tip of the guide where the irregular curves are 18/32nds of a inch wide. There is a tapped hole for a set screw located near the center of the RAZOR TIP on one of it's 3 inch long sides. It is located approximately 1⅜th inches from the tip of the wedged side of the RAZOR TIP, and protrudes through the ⅛th inch wall of the RAZOR TIP. It is formed by using a tap drill 0.1360 of a inch in diameter. It's for a size 8 course thread screw (32 threads per inch).

1. I claim as my invention the RAZOR TIP carpenter's pencil sharpening guide.

2. I claim that the following two elements serve a unique function in the operation of the RAZOR TIP.
A) The 36 degree wedge shaped guide surface located on the RIGHT SIDE of the TOP VIEW (see FIG. 1 of drawings) is a exclusive feature of this invention.
B) The irregular curve shaped guide surfaces including their offset dimensions located on the LEFT SIDE of the TOP VIEW (see FIG. 1 of the drawings) are a exclusive feature of this invention.
